(19) United States
(12) Patent Application Publication
(10) Pub. No.: US 2020/0408322 A1
(43) Pub. Date: Dec. 31, 2020

(54) Non-Return Valve for a Solenoid Valve and Associated Solenoid Valve

(71) Applicant: Robert Bosch GmbH, Stuttgart (DE)

(72) Inventor: Dirk Foerch, Neuenstadt/Stein (DE)

(21) Appl. No.: 16/910,473

(22) Filed: Jun. 24, 2020

(30) Foreign Application Priority Data
Jun. 26, 2019 (DE) 10 2019 209 285.3

(51) Int. Cl. F16K 31/06; B60T 8/34; B60T 8/36

(52) U.S. Cl. CPC F16K 31/0655; F16K 15/04; B60T 8/363; B60T 8/341

(57) ABSTRACT

A non-return valve for a solenoid valve includes a movable closure element and a valve structural element with a valve seat that is arranged on a through-opening to perform a direction-orientated throughflow and sealing function. The valve seat has a first region and a second region. The first region of the valve seat forms a support region for a sealing element in order to absorb a supporting force with respect to the closure element. The second region of the valve seat forms a sealing region in order to enable sealing with respect to the closure element. A solenoid valve in one embodiment includes the non-return valve.

This application claims priority under 35 U.S.C. § 119 to patent application no. DE 10 2019 209 285.3, filed on Jun. 26, 2019 in Germany, the disclosure of which is incorporated herein by reference in its entirety.

### BACKGROUND

The present disclosure relates to a non-return valve for a solenoid valve having a movable closure element and a valve structural element with a valve seat which is arranged on a through-opening for performing a direction-orientated throughflow and sealing function, is characterized in that the valve seat has a first region and a second region, wherein the first region of the valve seat forms a support region for the sealing element in order to absorb a supporting force with respect to the closure element, wherein the second region of the valve seat forms a sealing region in order to enable sealing with respect to the closure element, and an associated solenoid valve.

A conventional solenoid valve, in particular for a hydraulic system which is used, for example, in an anti-lock braking system (ABS) or a traction control system (TCS) or an electronic stability program system (ESP system) is illustrated in FIG. 1. As can be seen in FIG. 1, the conventional solenoid valve 1 which is constructed, for example, as a powerlessly open control valve, comprises a magnet sub-assembly 3 for producing a magnetic flux which comprises a housing cover 2.1, a winding carrier 2.2, a coil winding 2.3 and a covering plate 2.4, and a valve cartridge 5, which comprises a capsule 5.1, a valve insert 10 which is connected to the capsule 5.1 by means of a seal weld 4, an armature 6 having a tappet 7 and a restoring spring 8. The magnet sub-assembly 2 produces as a result of an application of current to the coil winding 2.3 via electrical connections 2.5 a magnetic force which moves the longitudinally movable armature 6 with the tappet 7, which comprises a closure element 7.1 with a main sealing element 7.2, counter to the force of the restoring spring 8 against the valve insert 10. The valve insert 10 directs the magnetic flux introduced from the magnet sub-assembly 2 via the covering plate 2.4 axially via an air gap 3 in the direction of the armature 6.

In addition, the valve insert 10 receives the so-called valve member 11 which comprises a main valve seat 11 in which the main sealing element 7.2 which is configured as a sealing cap is introduced in a sealing manner in order to implement the sealing function of the solenoid valve 1. For caulking with a fluid block, a caulking flange 9 is formed on the valve insert 10. As can further be seen in FIG. 1, the conventional solenoid valve 1 comprises a non-return valve 12 which is arranged eccentrically relative to the valve main axis 1.1 in a bypass with respect to the main valve and which performs a direction-orientated throughflow and sealing function. This means that the non-return valve 12 is closed through a first fluid flow direction and is opened through a fluid flow direction opposite the first fluid flow direction in the through-hole 14.3. As significant components, the non-return valve 12 of the conventional solenoid valve 1 comprises a movable closure element 15, a valve seat 14.4 which is arranged in a valve structural element 14 and a stroke limitation or abutment which is formed in this instance by a flat filter 13 in order to limit the maximum stroke of the movable sealing element 15.

As can be seen in the left half of the detailed illustration, the non-return valve 12 which is positioned eccentrically relative to the valve main axis 1.1 is generally in the form of a spherical hollow cone, that is to say, the closure element 15 is configured as a sphere and the valve seat 14.4 which is arranged in the valve structural element 14 is in the form of a hollow cone. The valve structural element 14 which is configured as a plastics material insert forms the valve lower portion and additionally serves to seal with respect to a surrounding fluid block, to seal with respect to the valve member 10 and to receive a ring filter and the flat filter 13. The closure element 15 which is configured as a sphere is carried by the fluid flow and a first region 15.1 (sealing region) of the closure element 15 is pressed into the valve seat 14.4 which is configured as a hollow cone. As the system pressure increases, for example, when a brake pedal is activated or in the event of an active pressure build-up in an anti-lock braking system (ABS) or in an electronic stability program system (ESP system), the closure element 15 is pressed more powerfully into the valve seat 14.4 and seals with the same first region 15.1 in the valve seat 14.4 and retains with increasing sealing as the pressure difference increases. In the opening direction, the sealing element 15 is placed by the fluid flow against the abutment 13.1 and the fluid can flow freely through the through-hole 14.3. The valve structural element 14 further comprises a guide region 14.6, which spatially directly adjoins the valve seat 14.4. This guide region 14.6 limits the movement possibilities of the closure element 15 in the open state and consequently defines a guiding of the closure element 15.

The patent application DE 10 2007 042 717 A1 is known from the prior art. This document describes a possible advantageous embodiment for such a non-return valve having a peripheral sealing lip.

The patent application DE 10 2016 212 562 A1 is further known from the prior art. This document relates to a non-return valve for a solenoid valve, having a non-return valve seat which is arranged on the edge of a fluid channel and a movable closure element for performing a direction-orientated throughflow and sealing function, wherein the closure element has a sealing cone, an abutment base and a resilient sealing ring which is arranged between the abutment base and the sealing cone, wherein the abutment base in the event of sealing forms a support face for the resilient sealing ring, and a solenoid valve having such a non-return valve.

### SUMMARY

Advantageously, however, the non-return valve according to the disclosure enables an optimized functionality, in particular improved sealing and stability. This is enabled according to the disclosure by the features set out in the independent patent claims. Other embodiments of the disclosure are set out in the dependent claims.

The non-return valve according to the disclosure for a solenoid valve having a movable closure element and a valve structural element having a valve seat which is arranged on a through-opening for performing a direction-orientated throughflow and sealing function, is characterized in that the valve seat has a first region and a second region, wherein the first region of the valve seat forms a support region for the sealing element in order to absorb a supporting force with respect to the closure element, wherein the second region of the valve seat forms a sealing region in order to enable sealing with respect to the closure element.

This is intended to be understood to mean that the valve seat contains at least two functional elements. The valve seat accordingly forms for these functions which are intended to be performed separate elements for the implementation thereof. Advantageously, it is thereby possible to optimize the functionality. The formation of the first region on the valve seat, that is to say, the configuration of the first functional element, enables extensive protection from plastic deformation of the valve seat in the event of high pressure differences. The formation of the second region on the valve seat, that is to say, the configuration of the second functional element enables a significant increase of the sealing function, in particular in the low-pressure range at low pressures. Furthermore, it is also possible, for example, for a non-circular portion of the valve seat to be compensated for as a result of the configuration of the second region of the valve seat as resiliently sealing.

The two functional elements are further constructed in different regions of the valve seat, that is to say, they are spatially separated from each other. It is thereby made possible for the desired functionality in each case to be achieved in the best possible manner by means of the configuration of the respective region.

A valve seat of the non-return valve is intended to be understood to be the region which directly adjoins the through-opening. The valve seat is therefore the region which together with the closure element enables the closure of the non-return valve. The valve seat is in this instance from a structural viewpoint a substantially uniformly constructed region, for example, a funnel (that is to say, a hollow-cylindrical tapering/expansion). As illustrated in FIG. 2, the valve structural element may contain a guide region. If such a guide region is formed, the valve seat is the region which is formed between the through-opening and the guide region.

The first region of the valve seat, which enables the support of the closure element, is advantageously constructed in a peripheral manner with respect to the valve seat. Furthermore, the second region of the valve seat which enables the sealing with respect to the closure element is advantageously constructed in a peripheral manner with respect to the valve seat.

The first region is, for example, constructed in the form of a hollow cone. Alternatively, the first region may be constructed as a portion of a hollow sphere. Advantageously, the region is constructed as a surface. The second region is, for example, constructed in the manner of a hollow cone. Advantageously, the region is constructed as a surface.

In an advantageous embodiment, the non-return valve is characterized in that the first region and the second region of the valve seat interact with the closure element in the closed state of the non-return valve.

This is intended to be understood to mean that both the first region of the valve seat is in contact with the closure element and the second region of the valve seat is in contact with the closure element when the non-return valve is closed. Two direct contact regions are thus formed between the valve structural element and the closure element.

In one possible embodiment, the non-return valve is characterized in that the valve seat is configured as a hollow cone and the first region and the second region of the valve seat are formed inside the hollow cone.

This is intended to be understood to mean that the valve seat is constructed substantially in the form of a hollow cone. In this instance, both the support region and the sealing region are formed inside the hollow cone.

In a preferred embodiment, the non-return valve is characterized in that the first region of the valve seat is formed with respect to the second region of the valve seat spatially further in the direction of the tapering of the hollow-cone-shaped valve seat.

This is intended to be understood to mean that both the support region and the sealing region are configured inside the hollow-cone-shaped valve seat. The first region (that is to say, the support region) is located in this instance spatially further in the direction of the tapering of the hollow-cone-shaped valve seat—in comparison with the second region (that is to say, the sealing region). The second region is accordingly located spatially further in the direction of the opening region of the hollow-cone-shaped valve seat—in comparison with the first region.

In an alternative development, the non-return valve is characterized in that the first region of the valve seat is constructed integrally with the valve structural element.

This is intended to be understood to mean that the support region is produced as an integrated element of the valve structural element directly when the valve structural element is produced. In particular, the valve structural element and the integrated support region is produced by means of an injection-molding method.

In an advantageous embodiment, the non-return valve is characterized in that the second region of the valve seat is constructed integrally with the valve structural element.

This is intended to be understood to mean that the sealing region is produced as an integrated element of the valve structural element directly when the valve structural element is produced. In particular, the valve structural element and the integrated sealing region are produced by means of an injection-molding method. This is further intended to be understood to mean that both the first region and the second region of the valve seat are formed from one piece together with the valve structural element. In particular that both the first region of the valve seat is constructed as a support region and the second region of the valve seat is constructed as a sealing region in a state integrated in the valve structural element.

In a possible embodiment, the non-return valve is characterized in that the first region and the second region of the valve seat are constructed as part of the valve structural element with the injection-molding method.

In a preferred development, the non-return valve is characterized in that the second region of the valve seat is constructed as a sealing lip, in particular as a resilient peripheral sealing lip, against which the closure element abuts in a sealing manner in order to perform a sealing function.

This is intended to be understood to mean that the closure element is pressed against the resilient second region of the valve seat in order to perform the sealing function. A pressing action may, for example, be carried out by means of fluid pressure. As a result of the pressing pressure, a resilient deformation of the second region of the valve seat can be produced. In this instance, it should be noted that a support of the abutment forces of the closure element is carried out by means of the first region of the valve seat, against which the closure element is also pressed but which substantially carries out no resilient deformation.

In an alternative embodiment, the non-return valve is characterized in that, in order to form the sealing lip, an undercut is introduced into the second region of the valve seat and predetermines a wall thickness which acts as a sealing lip with respect to the through-opening.

Consequently, the sealing lip can be implemented in a simple and cost-effective manner by means of a small structural change of the valve seat. By the valve seat of the non-return valve being provided with an undercut, the thinned wall which is configured as a sealing lip may give way when pressure is applied and may closely fit the sealing element. The undercut is, for example, configured as a peripheral annular groove. In addition, the resilience of the peripheral sealing lip may be predetermined by the depth of the undercut and/or the positioning of the undercut on the valve seat.

In an advantageous development, the non-return valve is characterized in that the closure element does not comprise any resilient sealing element and is constructed in particular as a sealing ball.

This is intended to be understood to mean that the closure element corresponds to a simple and consequently cost-effective embodiment. For example, the closure element has a spherical shape. In particular, it is configured as a sphere. Advantageously, the closure element is constructed as a steel ball. The closure element further has no resilient sealing element—neither an integrated one nor a separate one—such as, for example, by means of sealing rings.

In one possible embodiment, the non-return valve is characterized in that the closure element is supported, in order to perform the sealing function, with a first region on the first region of the valve seat and seals with a second region on the second region of the valve seat, wherein in particular the closure element, in order to perform the throughflow function, abuts an abutment and releases the valve seat, wherein the abutment is arranged opposite the valve seat.

This is intended to be understood to mean that the non-return valve performs both functions: the sealing function and throughflow function. As already indicated, in order to enable the sealing function the closure element abuts with a first region of the closure element against the first region of the valve seat and is supported thereon. Furthermore, the closure element, in order to enable the sealing function, abuts with a second region of the closure element against the second region of the valve seat and thereby seals. In order to enable the throughflow action, the closure element is moved away from this position and abuts an abutment region which is positioned opposite.

Furthermore, a solenoid valve is provided having a magnet sub-assembly and a valve cartridge which comprises an armature which is movably guided inside a capsule, a valve insert, a tappet which is movably guided inside the valve insert and which has a closure element having a main sealing element and a valve member having a main valve seat, wherein between a fluid inlet and a fluid outlet there is arranged a main valve which comprises the main sealing element which is connected to the closure element and the main valve seat which is arranged in the valve member, wherein a magnetic force which is produced by the magnet sub-assembly moves the armature and the tappet, wherein the main sealing element, in order to perform a sealing function, is introduced in a sealing manner into the main valve seat. According to the disclosure, the solenoid valve is characterized by a non-return valve as described above, wherein the non-return valve is arranged in a bypass with respect to the main valve and performs a direction-orientated throughflow and sealing function.

### BRIEF DESCRIPTION OF THE DRAWINGS

It should be noted that the features set out individually in the description can be combined with each other in any technically advantageous manner, and set out other embodiments of the disclosure. Other features and advantages of the disclosure will be appreciated from the description of embodiments with reference to the appended drawings.

In the drawings:

FIG. 1 is a schematic sectioned view of a solenoid valve having a non-return valve, and

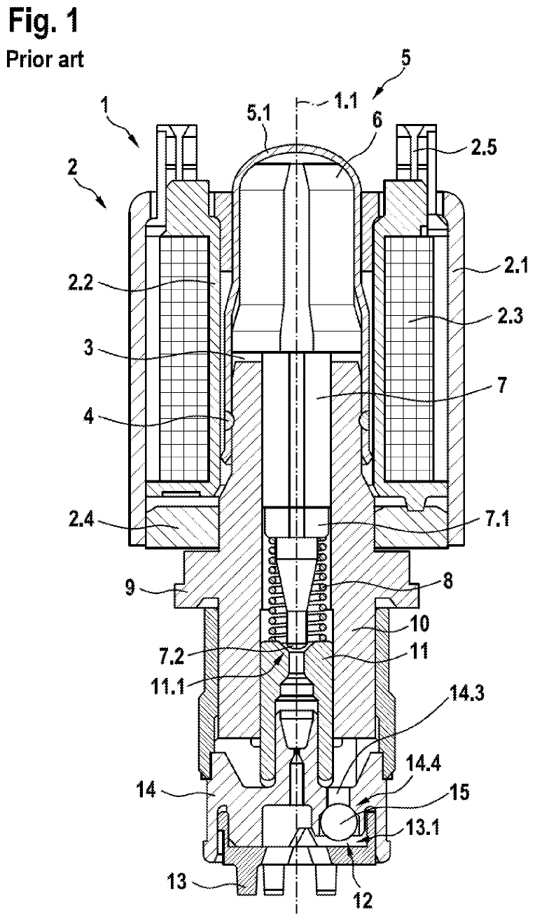

FIG. 2 is a detailed illustration of the non-return valve according to the prior art (left half of the image) and an embodiment of the disclosure (right half of the image).

### DETAILED DESCRIPTION

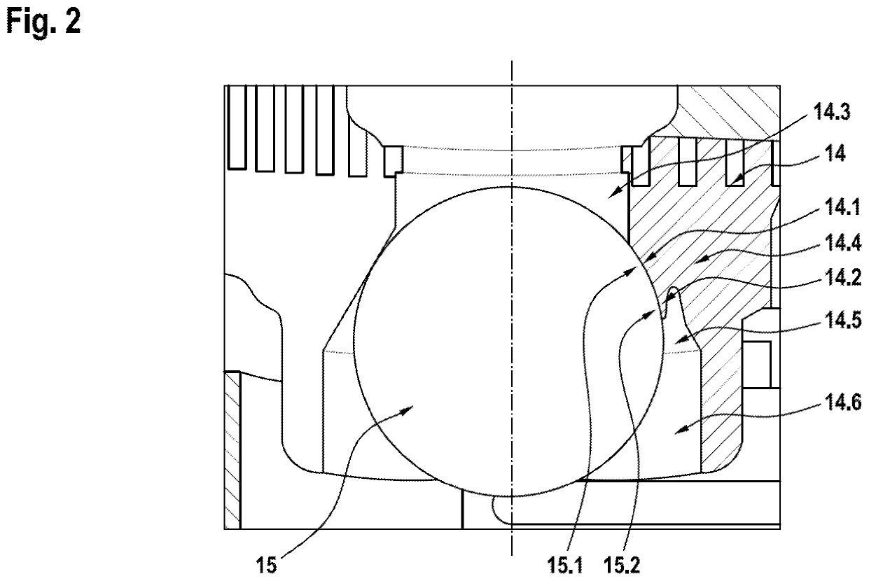

In FIG. 2, in the right half of the image a detailed illustration of the non-return valve according to an embodiment of the disclosure is shown. The valve seat 14.4 is configured substantially in the form of a hollow cone. This hollow-cone-shaped region comprises a first region 14.1 and a second region 14.2.

The first region 14.1 of the valve seat 14.4 forms a support region, on which the closure member 15 is supported with a first region 15.1. The second region 14.2 of the valve seat 14.4 forms a sealing region, on which the closure member 15 is sealed with a second region 15.2.

The first region 14.1 is located spatially further in the direction of the tapering of the hollow-cone-shaped valve seat 14.4—in comparison with the second region 14.2. The first region 14.1 forms a peripheral support face. At this location, supporting forces with respect to the closure member 15 can be absorbed by the valve seat 14.4 and introduced into the valve component 14. A plastic deformation of the valve seat in particular at high differential pressures is thereby prevented.

The second region 14.1 is located spatially further in the direction of the opening region of the hollow-cone-shaped valve seat 14.4—in comparison with the first region 14.1. The second region 14.2 forms in this instance a sealing face. This sealing face is configured as a peripheral sealing lip. In order to form the sealing lip, an undercut 14.5 is introduced into the valve seat 14.4. This undercut 14.5 predetermines the wall thickness which acts as a sealing lip. The undercut 14.5 is in this instance constructed, for example, as a peripheral annular groove. The sealing lip may have been produced directly using the injection-molding method. Alternatively, the undercut 14.5 may have been produced subsequently by means of, for example, machining methods. The resilience of the sealing lip can be defined by the depth of the undercut 14.5 and/or by means of the positioning of the undercut 14.5 on the valve seat 14.4. Accordingly, the sealing lip is capable of constituting the sealing by means of resilient deformation. Furthermore, for example, a non-circular portion of the valve seat 14.4 can also be compensated for as a result of the dimension-related increased flexibility of the sealing lip.

What is claimed is:

1. A non-return valve for a solenoid valve, comprising:
a movable closure element; and
a valve structural element having a valve seat arranged on a through-opening in order to perform a direction-orientated throughflow and sealing function,
wherein the valve seat has (i) a first region that forms a support region for the closure element in order to absorb a supporting force with respect to the closure element and (ii) a second region that forms a sealing region in order to enable sealing with respect to the closure element.

2. The non-return valve according to claim 1, wherein the first region and the second region of the valve seat interact with the closure element in a closed state of the non-return valve.

3. The non-return valve according to claim 1, wherein the valve seat is configured as a hollow cone, and wherein the first region and the second region of the valve seat are formed inside the hollow cone.

4. The non-return valve according to claim 3, wherein the first region is formed with respect to the second region spatially further in the direction of the tapering of the hollow-cone-shaped valve seat.

5. The non-return valve according to claim 1, wherein the first region of the valve seat is configured integrally with the valve structural element.

6. The non-return valve according to claim 1, wherein the second region of the valve seat is configured integrally with the valve structural element.

7. The non-return valve according to claim 1, wherein the first region and the second region of the valve seat are configured as part of the valve structural element via an injection-molding method.

8. The non-return valve according to claim 1, wherein the second region of the valve seat is configured as a sealing lip against which the closure element abuts in a sealing manner to perform a sealing function.

9. The non-return valve according to claim 8, wherein, in order to form the sealing lip, an undercut is introduced into the second region of the valve seat and predetermines a wall thickness which acts as a sealing lip with respect to the through-opening.

10. The non-return valve according to claim 1, wherein the closure element does not comprise any resilient sealing element.

11. The non-return valve according to claim 1, wherein the closure element, in order to perform the sealing function, is supported with a third region on the first region of the valve seat and seals with a fourth region on the second region of the valve seat.

12. A solenoid valve, comprising:
a magnet sub-assembly;
a valve cartridge that includes:
a capsule,
an armature that is movably guided inside the capsule,
a valve insert,
a tappet which is movably guided inside the valve insert and which has a closure element having a main sealing element, and
a valve member having a main valve seat,
wherein between a fluid inlet and a fluid outlet there is arranged a main valve which comprises the main sealing element which is connected to the closure element and the main valve seat which is arranged in the valve member, wherein a magnetic force which is produced by the magnet sub-assembly moves the armature and the tappet, and wherein the main sealing element, in order to perform a sealing function, is introduced in a sealing manner into the main valve seat; and
a non-return valve arranged in a bypass with respect to the main valve and configured to perform a direction-orientated throughflow and sealing function, the non-return valve including:
a movable closure element, and
a valve structural element having a valve seat arranged on a through-opening in order to perform the direction-orientated throughflow and sealing function, the valve seat having (i) a first region that forms a support region for the closure element in order to absorb a supporting force with respect to the closure element and (ii) a second region that forms a sealing region in order to enable sealing with respect to the closure element.

13. The non-return valve according to claim 8, wherein the sealing lip is a resilient peripheral sealing lip against which the closure element abuts in the sealing manner to perform the sealing function.

14. The non-return valve according to claim 10, wherein the closure element is configured as a sealing ball.

15. The non-return valve according to claim 11, wherein the closure element, in order to perform the throughflow function, abuts an abutment and releases the valve seat, the abutment arranged opposite the valve seat.
